(19) United States
(12) Patent Application Publication
(10) Pub. No.: US 2023/0168352 A1
(43) Pub. Date: Jun. 1, 2023

(54) METHOD FOR ASSESSING A MEASURING INACCURACY OF AN ENVIRONMENT DETECTION SENSOR

(71) Applicant: Continental Autonomous Mobility Germany GmbH, Ingolstadt (DE)

(72) Inventors: Peter Barth, Wolnzach (DE); Kilian Grundl, Munchen (DE)

(73) Assignee: Continental Autonomous Mobility Germany GmbH, Ingolstadt (DE)

(21) Appl. No.: 18/060,250

(22) Filed: Nov. 30, 2022

(30) Foreign Application Priority Data
Nov. 30, 2021 (DE) 10 2021 213 525.0

(51) Int. Cl. G01S 7/497; G01S 7/40; G01C 22/00; G01S 17/08; G01S 13/08

(52) U.S. Cl. CPC G01S 7/497; G01S 7/40; G01C 22/00; G01S 17/08; G01S 13/08

(57) ABSTRACT

A method for assessing measuring uncertainties of at least one environment detection sensor of an ego vehicle is disclosed. The method includes recording an environment of the ego vehicle by means of at least one environment detection sensor; detecting at least one object which is located in a region in front of the ego vehicle in the direction of travel; specifying a sensor output of at least one environment detection sensor as a ground truth when a specifiable minimum distance between the ego vehicle and the detected object is fallen short of; calculating a position of the object in relation to the ego vehicle at an earlier point in time based on data of a system for positioning; comparing a sensor output at the earlier point in time with the calculated position of the object; and assessing the measuring inaccuracy based on a result of the comparison.

### CROSS-REFERENCE TO RELATED APPLICATIONS

The present application claims the benefit and/or priority of German Patent Application No. 10 2021 213 525.0 filed on Nov. 30, 2021, the content of which is incorporated by reference herein.

### BACKGROUND

In many fusion systems, statistical estimators are used in order to fuse and/or track objects or raw data. One of the best-known methods is the Kalman filter and its offshoots. In many of these estimators (but, especially, also in the Kalman filter), a part of the fusion/tracking input is the measuring inaccuracy of the sensor datum.

There are substantially two methods which can be utilized for the a priori determination of this measuring inaccuracy. On the one hand, the sensor manufacturer's details regarding the measuring inaccuracy are used and entered in accordance with the setup. These were then created, e.g., in accordance with ISO/IEC Guide 98-3. On the other hand, the required measuring inaccuracy is compared by trial & error or with ground truth data and is then statistically estimated.

The disadvantage of the aforementioned methods is that the details provided by the sensor manufacturers refer to the measuring inaccuracy of the sensor itself, but not to the specific construction/use of the sensor in the system. Furthermore, especially in fusion systems having pre-processing (e.g., single-sensor object tracking, data stabilization, etc.), the measuring inaccuracies are modified by precisely these pre-processing operations.

### SUMMARY

It is therefore an object of the present disclosure to provide a method which makes it possible to reliably and precisely determine the measuring inaccuracy of an environment detection sensor.

This is addressed by the subject-matter of the independent claim 1 as well as the independent claim 8. Further advantageous configurations of the present disclosure are the subject-matter of the subclaims.

Initial considerations were that, for example, the position inaccuracies of extracted pedestrians from a camera image are not only dependent on the measuring inaccuracy of the camera itself, but also on the extraction algorithms, the assumptions used, the installation, position, etc. of the camera, of the lens used. As a further example, radar objects which are already pre-tracked by a Kalman filter are, e.g., used in the environment model and, consequently, the pure sensor measuring inaccuracies can no longer be directly applied to a downstream fusion.

In all cases, there exists the problem that the precise measuring inaccuracies of the sensor outputs are not known, which impairs the fusion results. Equally, under these conditions, it is not possible to use the measuring inaccuracies indicated by the manufacturer of the corresponding sensor. However, an exact determination of the measuring inaccuracies ranges from complex to not yet technically possible. Therefore, it was a basic idea of the present disclosure to utilize a statistical estimation in order to assess the measuring uncertainty.

According to the present disclosure, a method for assessing measuring uncertainties of at least one environment detection sensor of an ego vehicle, having the following steps, is therefore proposed:
recording an environment of the ego vehicle by means of at least one environment detection sensor;
detecting at least one object which is located in a region in front of the ego vehicle in the direction of travel;
specifying a sensor output of the at least one environment detection sensor as a ground truth when a specifiable minimum distance between the ego vehicle and the detected object is fallen short;
calculating a position of the object in relation to the ego vehicle at an earlier point in time based on data of a system for positioning;
comparing the sensor output at the earlier point in time with the calculated position of the object; and
assessing the measuring inaccuracy based on a result of the comparison.

The environment detection sensor can, for example, be a radar sensor, a camera or a lidar sensor. It would also be conceivable to use multiple sensors, wherein the sensors can be different or the same. For example, a combination of radar and camera could be used, wherein any possible combination of the same and different sensors is also conceivable. The method is carried out accordingly for the sensors. It would also be conceivable to use multiple sensor outputs of a sensor instead of one sensor output and to average these out and define the average produced as a ground truth. When using multiple sensors, an averaging of the sensor outputs of the individual sensors can also be used, for example, as a sensor output, if a minimum distance from the detected object has been reached for all sensors.

This is based on the assumption that the extraction or positioning is more precise close to the vehicle, that is to say accordingly at a shorter distance, than over long distances. Therefore, the use of such a minimum distance is particularly advantageous.

The region in front of the ego vehicle comprises not only one region directly in front of the vehicle, but also regions which are located laterally in front of the vehicle. The object is established by the recording of the environment detection sensor.

The sensor output at the earlier point in time includes a detection of the object and, consequently, the detected position at this point in time. This sensor output is then compared with the calculated position.

A further basic assumption is that the positioning or calculation is more precise and subject to fewer errors than the sensor output.

As a result, it is possible to estimate the sensor measuring inaccuracies specific to the sensor and construction, which estimates can be deployed later, for example, in a fusion system.

In a further configuration, a real-time kinematics system or odometry system is used for positioning. The number of wheel revolutions is used by the odometry system in order to determine the position and orientation of the ego vehicle. The RTK (real-time kinematics) system uses GNSS satellite signals from geodetic receivers for positioning. The transmitters/receivers or sensors necessary for the respective positioning are provided, according to the configuration, in the ego vehicle. For example, a wheel speed sensor is installed for the odometry system.

Moreover, in a particular embodiment, the object is a further road user, a feature of the surroundings or a landmark. It would also be conceivable to establish multiple road users and the distances from these. Furthermore, it would also be conceivable to detect a combination of the aforementioned objects and to determine, in each case, the distance from the ego vehicle.

The estimated measuring inaccuracy is particularly provided to a sensor fusion system and/or a driver assistance system. This is in particular advantageous since the driver assistance systems and sensor fusion systems can include the measuring uncertainty, as a result of which the accuracy and reliability of these systems are increased.

In a further configuration, it is provided that, in addition to determining the distance, at least one angle between the object and ego vehicle is established. This is advantageous since, in this way, objects or road users or similar can also be considered, which are not located directly in front of the ego vehicle. Furthermore, the angle between the object and the ego vehicle, more precisely between the object and the direction of travel of the ego vehicle, has an influence on the measuring inaccuracy. Accordingly, the measuring inaccuracy can likewise be greater in the case of a larger angle.

In a further configuration, further environmental factors are considered for the determination of the measuring uncertainty. Depending on the prevailing environmental factors, the sensor or sensors used can be accordingly adversely affected.

Moreover, environmental factors such as current weather conditions or the time of day are considered. For example, the measuring inaccuracy can be higher when it is raining than in clear weather conditions. Rain can, for example, influence the detection of the camera and radar sensors. Accordingly, it is advantageous to consider such conditions when estimating the measuring inaccuracy. Likewise, the detection accuracy of a camera can be worse at night, for example, than during the day or in the evening due to the low position of the sun due to scattered light influences. Accordingly, it is advantageous to consider such environmental factors as well.

Furthermore, the data regarding angles, the weather conditions and the times of day can be stored and provided, for example, to a fusion system if a corresponding driving scenario, e.g., including rain and night driving is recognized. Consequently, a measuring inaccuracy can be advantageously provided from the outset.

The data obtained by the method are collected and processed in a computing device. The sensor data are collected from a plurality of journeys, in different weather conditions and at different times of day and, based thereon, a plurality of measuring uncertainties for different scenarios is estimated. This plurality of measuring uncertainties can then be provided to a vehicle so that when a particular scenario is recognized, the vehicle can determine the correct measuring uncertainty without having to process a large amount of data in the vehicle itself.

By way of example, the method is to be illustrated using an example with a radar sensor. The radar sensor measures the position of other road users. A static road user towards which the vehicle is moving is selected for the method. As soon as the vehicle falls short of a minimum distance from the static road user, the sensor output is defined as a ground truth. Here, it would also be conceivable for multiple radar data or sensor outputs of the radar to be averaged out and the average produced to be defined as a ground truth. Thanks to the data of a system for positioning, this position can now be calculated in relation to the ego vehicle at an earlier point in time and compared with the sensor measurement at that time. This technology can be used for any number of road users as well as for any small/large distances as well as, additionally, angles of the road users with respect to the ego vehicle. Furthermore, environmental factors such as weather conditions and/or the time of day can be additionally considered.

Furthermore, according to the present disclosure, a system for determining measuring uncertainties is provided, including at least one environment detection sensor, by means of which an environment of an ego vehicle is recorded and an object can be detected, a system for positioning as well as a processor which receives a plurality of measuring uncertainties from an external computing device, and wherein the computing device is configured to determine a measuring uncertainty from the plurality of measuring uncertainties, based on the sensor data. Moreover, further factors such as, for example, weather conditions, the time of day and/or angle with respect to the detected object can be enlisted in the vehicle or by the processor to determine the measuring inaccuracy. Based on the data, the corresponding measuring uncertainty is determined and selected from the plurality of measuring uncertainties. The processor and the external computing device are communicatively connected, for example, via a wireless data connection.

The processor can be arranged in a central control unit, e.g., an ECU. It would also be conceivable for the processor to be arranged in the environment detection sensor. If there are multiple environment detection sensors, the processor could be arranged in one of the sensors. The environment detection sensor, the processor as well as the system for positioning are connected to one another via a data connection in order to be able to transmit data.

Depending on how the assessed measuring uncertainty continues to be used, the processor may additionally be connected to a driver assistance system in order to forward the measuring uncertainty to the driver assistance system.

In a configuration, the system for positioning is a real-time kinematics system or odometry system.

### BRIEF DESCRIPTION OF THE DRAWINGS

Further advantageous configurations of the present disclosure are the subject-matter of the drawings, wherein:

FIG. 1 shows a schematic flow chart of the method according to an embodiment of the present disclosure; and

FIG. 2 shows a schematic representation of a system according to an embodiment of the present disclosure.

### DETAILED DESCRIPTION

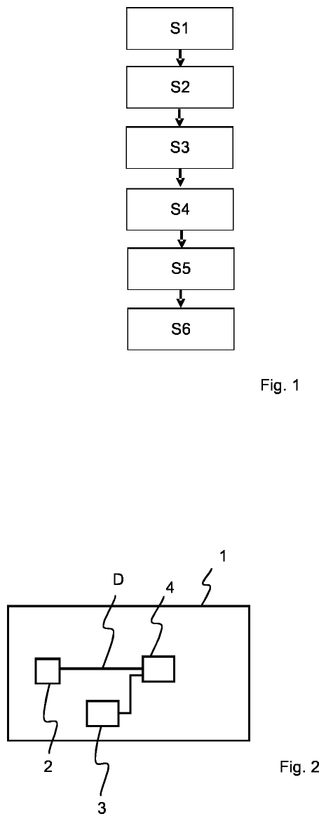

A schematic flow chart of the method according to an embodiment of the present disclosure is shown in FIG. 1. In step S1, an environment of the ego vehicle is recorded by means of at least one environment detection sensor 2. In step S2, at least one object is detected, which is located in a region in front of the ego vehicle in the direction of travel. In step S3, a sensor output of at least one environment detection sensor is specified as a ground truth when a distance between the ego vehicle and the detected object falls short of a specifiable minimum distance. In step S4, a position of the object in relation to the ego vehicle at an earlier point in time is calculated, based on data of a system for positioning 3. In step S5, a sensor output at an earlier point in time is compared with the calculated position of the object. Finally, the measuring inaccuracy is assessed, based on a result of the comparison, in step S6.

FIG. 2 shows a schematic representation of a system 1 according to an embodiment of the invention. The system 1 comprises at least one environment detection sensor 2, a system for positioning 3 as well as a processor 4. The environment detection sensor 2 as well as the system for positioning 3 are connected to the processor 4 via a data connection D. The data connection D can be wired or wireless. In this representation, the processor 4 is arranged, for example, in a central control unit, e.g., the ECU. It would also be conceivable for the processor 4 to be arranged in the environment detection sensor 2 for the execution of the corresponding method steps.

### LIST OF REFERENCE NUMERALS

1 System
2 Environment detection sensor
3 System for positioning
4 Processor
D Data connection
S1-S6 Method steps

1. A method for assessing measuring uncertainties of at least one environment detection sensor of an ego vehicle, comprising:
recording an environment of an ego vehicle by means of at least one environment detection sensor of the ego vehicle;
detecting at least one object which is located in a region in front of the ego vehicle in a direction of travel;
specifying a sensor output of at least one environment detection sensor as a ground truth when a distance between the ego vehicle and the detected object falls below a specifiable minimum distance between the ego vehicle and the detected object;
calculating a position of the object in relation to the ego vehicle at an earlier point in time based on data of a system for positioning;
comparing a sensor output at the earlier point in time with the calculated position of the object; and
assessing a measuring inaccuracy of the at least one environment detection sensor based on a result of the comparison.

2. The method according to claim 1, wherein a real-time kinematics system or odometry system is used for positioning.

3. The method according to claim 1, wherein the object is a further road user, a feature of the surroundings or a landmark.

4. The method according to claim 1, wherein the assessed measuring inaccuracy is provided to a sensor fusion system and/or a driver assistance system.

5. The method according to claim 1, further comprising establishing at least one angle between the object and ego vehicle.

6. The method according to claim 1, wherein assessing the measuring inaccuracy further comprises considering further environmental factors.

7. The method according to claim 6, wherein the further environmental factors comprise at least one of one or more current weather conditions or a time of day.

8. A system for assessing measuring uncertainties, comprising at least one environment detection sensor, by which an environment of an ego vehicle is recorded and an object is capable of being detected, a system for positioning as well as a processor which receives a plurality of measuring uncertainties from an external computing device, and wherein the computing device is configured to determine a measuring uncertainty from the plurality of measuring uncertainties, based on the sensor data.

9. The system according to claim 8, wherein the system for positioning is a real-time kinematics system or odometry system.
